(19) United States
(12) Patent Application Publication
(10) Pub. No.: US 2006/0143644 A1
(43) Pub. Date: Jun. 29, 2006

(54) Deletion order list for automatic video recorders

(75) Inventors: Wilhelmus Franciscus Johannes Verhaegh, Eindhoven (NL); Petrus Gerardus Meuleman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/544,196

(22) PCT Filed: Jan. 19, 2004
(86) PCT No.: PCT/IB04/50031

§ 371 Date: Aug. 2, 2005

(30) Foreign Application Priority Data
Feb. 5, 2003 (EP) 03100241.3

(51) Int. Cl. H04N 7/16

(52) U.S. Cl. 725/4

(57) ABSTRACT

A HHD-based video recorder has a content manager that indicates to the user which recorded content items are eligible for being deleted and in what order they are going to be deleted to free up storage capacity for content to be newly recorded.

### FIELD OF THE INVENTION

The invention relates to an information content managing system. The invention relates especially, but not exclusively, to features of a personal video recorder (PVR) that enable the user to manage the content stored on the PVR's hard disk drive (HDD).

### BACKGROUND ART

Within the field of consumer electronics (CE) digital content recorders, such as video recorders, are becoming increasingly widely used. Such a recorder receives content such as TV programs and downloaded movies and digitally records this content on a storage medium, typically on a HDD. The recorder's management system enables to automatically record content that matches one or more criteria. The user him/herself may explicitly specify what programs or movies are to be recorded or the system itself may select the content based on a preferences-profile of the user.

When the recorded content fully occupies the storage capacity of the recorder's storage medium, content to be newly recorded can only be stored if the recorded content is overwritten or deleted. For example, the Service Viewer's Guide for the Tivo PVR, edition 2002, states that the programs that have gotten recorded are saved until space is needed. By default, the oldest recordings are deleted to make room for the new ones whose recording the user has scheduled. The user has some control over this, in that he/she may specify what content is not to be overwritten or deleted. The user may also specify from which date on a specific recording may be deleted. The Tivo has a “Now Playing” information screen, listing all programs saved on the HDD. A colored icon to the left of each program title reflects how long each program will be saved. For example, a green icon indicates that the program will be saved until the user deletes it manually. A yellow icon indicates that the program will be deleted in less than one day if the need arises. A yellow icon with exclamation mark indicates that the associated program may be deleted at any time. A red icon indicates a program currently being recorded.

### SUMMARY OF THE INVENTION

In view of the above, the inventors propose to facilitate user interaction with such recorders and to provide to the user more ergonomic control options.

The invention therefore relates to a data processing system for recording content items in a storage medium. The system maintains a list or inventory of one or more particular ones of the recorded content items scheduled for being deleted from the storage medium. The scheduling is based on a predetermined content management strategy, e.g., first-in-first-out, most- (or: least-) frequently-accessed first; large sized items first, user-assigned preferences or priorities regarding the semantic content of the items, etc., or some combination of these strategies. Deleting these particular items frees up storage capacity for a new content item scheduled for being recorded. The system in the invention has an output for providing a representation of the list with an indication of an order wherein the particular items are scheduled for being deleted. For example, the representation is rendered on a display monitor and comprises a status report of the recorded items. The report graphically indicates the order wherein the particular items are going to be deleted. This is established by, e.g., having the titles of the particular items visually arranged in the order of scheduled deletion, or by showing an icon or a field accompanying each title carrying a number representative of the rank of that title in the order of deletion. Preferably, the system notifies a user of the list, e.g., upon a predetermined event. Examples of such an event include the following: the storage capacity of the storage medium decreases below a predetermined threshold; the user commands the system to provide a status of the storage medium; the system determines that there is not enough storage capacity available in view of a new item scheduled for being recorded; a new item appears on the list of candidates for being deleted, etc. Preferably, the system enables the user to modify the list, e.g., by removing items from the list or by changing their order.

Accordingly, the user is given an overview of the recorded items scheduled for being deleted. The order wherein they are scheduled for being deleted is represented by the ordered arrangement in the list. The absolute time and date of earliest deletion of a specific item, as in Tivo, is of hardly any interest to the user, as he/she compares the relevance of the specific item with the relevance of other items in the list. Note that the red, yellow and green icons in Tivo do not allow much differentiation regarding when a specific item is going to be deleted. Also, the icons require an interpretation by the user. In the invention, on the other hand, the list itself provides the relative relevance of the items based on their order that represents the order wherein they are going to be deleted or overwritten. The ordered arrangement provides the differentiation to enable to properly manage the content stored. In this manner, the list and operations thereon by the user form an intuitively simple tool for assisting the user with managing the available content in the storage medium.

The invention also relates to a method of providing a service to a user. The method comprises controlling storage capacity for storing electronic content items, and maintaining a list with at least a particular one of the recorded content items scheduled for being deleted to provide storage capacity for a new content item scheduled for being recorded. The method further comprises providing a representation of the list indicating an order wherein the particular items are scheduled for being deleted. Preferably, the method comprises enabling a user to be notified of the list, e.g., upon a predetermined event as mentioned above. Preferably, the method comprises enabling a user to modify the list.

Such a method is relevant to, e.g., a service on the Internet or on another data network, to which the user has delegated the management of content information, including the control of the recording of content, e.g., TV programs, emails or electronic documents supplied via a data network such as the Internet. The service may remotely control the user's recorder according to the user's preferences. Alternatively, the service may also provide storage capacity on the Internet.

An embodiment of the invention also relates to software for installation on a PVR or another data recording system. The software enables to maintain a list with one or more particular ones of multiple content items that have been recorded at the PVR and are scheduled for being deleted. Deletion provides storage capacity for a new content item scheduled for being recorded. The software enables to provide a representation of the list indicating an order wherein the particular items are scheduled for being deleted. Preferably, the software enables the user to modify the list, e.g., to modify the order. This software can be provided as an after-market module to upgrade PVRs in the field with this ergonomic control feature.

### BRIEF DESCRIPTION OF THE DRAWING

The invention is explained in further detail, by way of example and with reference to the accompanying drawing wherein:

FIG. 1 is a block diagram of a system in the invention; and

FIGS. 2 and 3 are tables giving the status of recorded programs.

Throughout the figures, same reference numerals indicate similar or corresponding features.

### DETAILED EMBODIMENTS

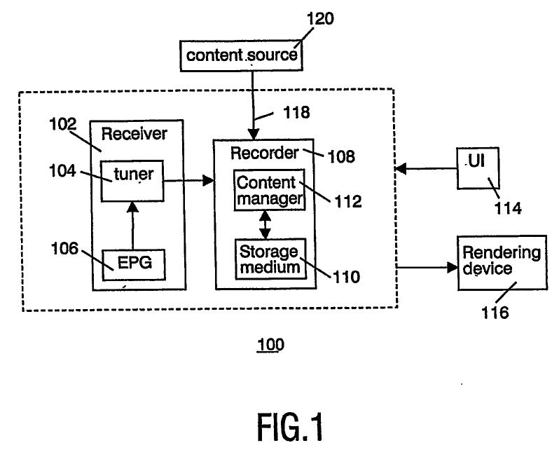

FIG. 1 is a block diagram of a system 100 in the invention. System 100 comprises a receiver 102 with a tuner 104 and an electronic program guide (EPG) 106. System 100 comprises a recorder 108 that has a storage medium 110, e.g., a HDD, and a content manager 112. System 100 further has a user interface (UI) 114 and a rendering device 116 such as display monitor and/or a loudspeaker. The functionalities of receiver 102 and recorder 108 may be integrated within a CE apparatus for use at the end-user's site. Alternatively, these functionalities may be geographically distributed. For example, both receiver and recorder may reside at the service provider, and the user has only to have a compatible UI 114 and rendering device 116. As another example, receiver 102 resides at the service provider and recorder 108 at the user's or the other way round, depending on the business model supporting the data supply or data recording services. As yet another example, receiver 102 and recorder 108 are separate entities on the user's home network.

Preferably, system 100 also comprises an input 118 for receipt of further content information 120 that can be stored at storage medium 110. Input 118 receives content information, e.g., via the Internet or another data network (e.g., home network) or from a mobile device of the user. For example, the user receives a periodical as an electronic document from a service on the Web. As another example, the user downloads his/her digital pictures from a digital camera on system 100 on system 100 via input 118. For simplicity, operation of system 100 is discussed below within the audio/video (AV) context determined by radio and television equipment. The above examples, however, make clear that the field of application of the invention is wider.

Tuner 104 can be tuned to a variety of channels that supply electronic content data via, e.g., a terrestrial network wireless or via cable, or a satellite. The content data may be supplied in a broadcast mode, in a multicast mode or in a unicast mode. In the latter mode, the user is provided with content uniquely edited according to his/her personal preferences as if he/she has a personal TV channel or radio channel. System 100 has, for example, an automatic receiving mode, wherein tuner 104 is tuned to a proper station or channel under combined control of EPG 106 and the preferences of a user, e.g., as entered via UI 114 or based on a profile acquired through a user history. Tuner 104 can supply the content directly to rendering device 116 so that the user receives the content live. Alternatively, tuner 104 can supply the content to recorder 108 to have it recorded on storage medium 110 for later use.

Recorder 108 has a content manager 112 that manages the content stored on medium 110, to be recorded on medium 110 and to be deleted from medium 110 as is explained below in further detail.

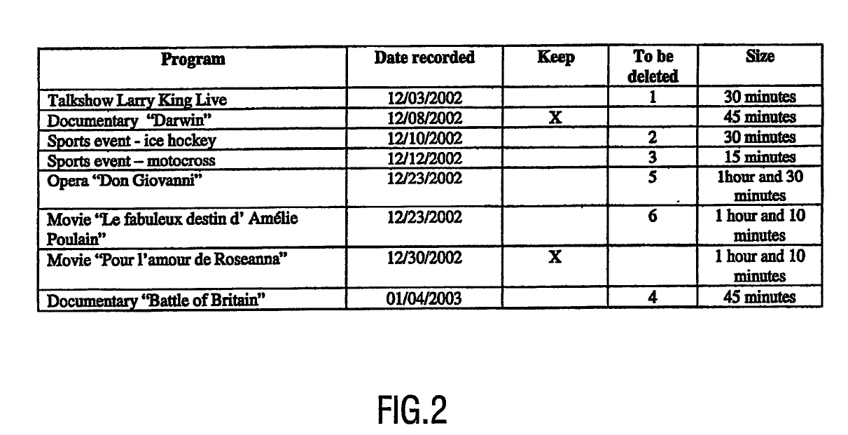

FIG. 2 is a table illustrating the operation of content manager 112 in the invention. The user is enabled to retrieve, e.g., via UI 114 and rendering device 116, an overview from content manager 112 with information about what programs have been recorded on medium 110 and their status. Alternatively, or in addition, content manager 112 notifies the user of the current inventory and status, e.g., when the user is programming recorder 108 for future recordings or when the user is about to play out a recorded program. The information retrieved is presented, for example, as a table with several columns and rows. The example table of FIG. 2 gives a title or description of the content recorded (here in the column with header “Program”); and the date at which it got recorded (in the column “Date recorded”). The table further indicates whether or not the recorded content is to be kept, i.e., is not to be deleted (in the column “Keep”); and the order wherein content eligible for being deleted is going to be deleted if new recordings overwrite it (in the column “To be deleted”). In this manner, the representation of the list of recorded items scheduled for deletion in integrated in the representation of the inventory of all recorded items. The title or description and the recording date have been obtained through EPG 106, for example. Preferably, the table also gives the approximate size of the program. The size is obtained through EPG 106 or is determined by content manager 112. The size is indicative of the program's duration and also, albeit roughly, of the storage capacity occupied. The size may be expressed in GB (Gigabytes) or hours of play time. Note that the duration need not be proportional to the storage capacity of the programs. Some programs may have been broadcast or recorded with a higher resolution than others. Preferably, therefore, content manager gives indications of both duration and storage capacity occupied. The former is relevant to the user when deciding what program will fit into the time slot he/she has reserved for watching the programs. The latter is relevant if the user wants to have an indication of what chunks of content occupy a larger piece of storage medium 110 in order to decide what to keep and in order to decide in what order the remainder can be overwritten by new content as is further explained below. A relative indication, e.g., a percentage or fraction of the storage space is adequate for these purposes, as the term “Gigabytes” is not interesting to the typical user.

The user is enabled to interact with content manager 112 and to indicate which recorded programs are to be maintained, i.e., are not to be overwritten. Interaction is accomplished through a suitable graphical user interface (GUI). Note that the invention relates in particular to a CE environment, wherein the user typically does not use a computer mouse as a means to control the equipment. In this CE environment, for example, a simple remote that is capable of transmitting IR commands can be used to navigate through a menu displayed on a display monitor, the menu having options arranged in a grid or a tree, or in a scrollbar. A jumping cursor or highlight guides the user through the grid or tree to select a menu option. An option in a scrollbar is selected by halting the scrolling when the desired option is made selectable. For example, to explicitly schedule “Amélie” as last in line of scheduled deletions, the user guides a highlight in the table of FIG. 2 to the field at the intersection of the row “Amélie” and the column “to be deleted”. Once the highlight is positioned, a drop-down menu appears from which the user can select, through the highlight, the highest number available, indicating a selection of last-in line in the sequence of programs to be deleted. Many alternative menus and UI interactions are possible.

In the example shown, the user has indicated he/she wants to keep the documentary about Darwin and the movie “Roseanna”. The remaining content entities are to be successively overwritten when a new recording is made, in the order as indicated in the “to be deleted” column. The talkshow is going to be deleted first. If more storage capacity is needed, the ice hockey game is going to be deleted. If yet more storage capacity is needed the motocross, the documentary about WW2, the opera and the movie about Amélie are going to be deleted in succession.

The order of deletion of the programs is automatically established according to, e.g., their recording date and time of the day, the preferences of the user regarding semantic category of the content (e.g., sports, talkshows, documentaries, movies, etc.), or the size of storage space occupied by the content item, or a weighted combination of two or more of these criterions. The user may have explicitly instructed content manager 112 to adopt a deletion order. Alternatively, content manager 112 determines a deletion order based on a profile of the user manually deleting or saving programs.

Preferably, the user is enabled to have content manager 112 arrange the information in different formats, e.g., arranged according to “date recorded” as is shown, or alphabetically under “Programs”, or arranged in the order of deletion, in order to facilitate user-interaction with content manager 112, or according to preference in a user profile.

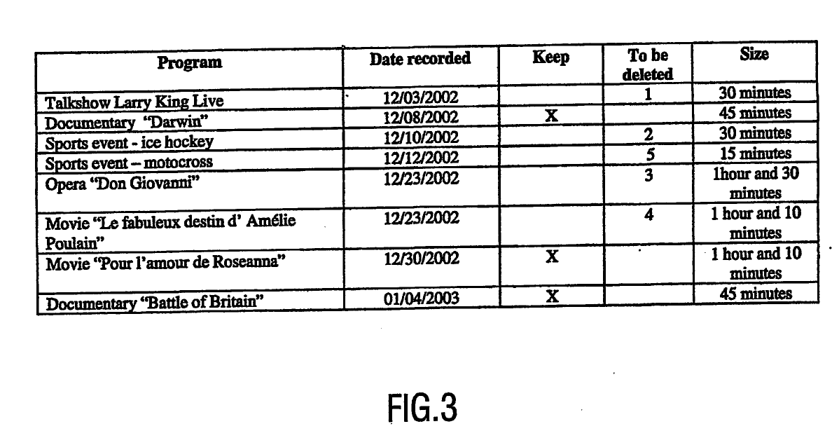

Assume that the user gets notified by content manager 112 of the inventory and status of medium 110 as given by the table of FIG. 2. Assume that the user now decides to prevent the documentary “Battle of Britain” from being deleted. Therefore, he/she supplies the proper input to content manager 112 through UI 114 so that this piece of stored content gets flagged as “not to be deleted”, resulting in its appearing with a mark in the column “keep” in a revised table. Assume that the user also wants to save the motocross content until all other programs, currently listed under “to be deleted”, have been overwritten. A proper input via UI 114 then causes the motocross to be flagged as last-in-line to be deleted, and the other remaining programs to be rearranged conserving the relative deletion order as shown by the revised table of FIG. 3.

Note that in another embodiment of system 100, the user is allowed to retrieve a representation of an ordered list showing only the items scheduled for being deleted. This ordered list then is the frame of reference to the user when he/she is to determine what to keep or what to let go first or what to let go in what order. The tables of FIGS. 2 and 3 provide more information than this, but a pruned version thereof is a suitable representation under these circumstances.

Note that adding a new item to storage medium 110 may alter the list of items scheduled for deletion. For example, consider a strategy that schedules recorded items for deletion according to semantic relevance of the item to the user. Assume that the user has subscribed to a service on the Web to receive a copy of a daily web page with news flashes. System 100 is programmed to automatically store this page at storage medium 110. The relevance of this item to the user is high the day of receipt, but is lower the day after. Accordingly, this page may automatically percolate through the list over time under control of system 100. Adding this item to the list may also be an example of an event that triggers system 100 to notify the user of the list.

For more background on an EPG, see, e.g., U.S. Ser. No. 09/568,932 (attorney docket US 000106) filed May, 11, 2000 for Eugene Shteyn and Rudy Roth for ELECTRONIC CONTENT GUIDE RENDERS CONTENT RESOURCES TRANSPARENT, incorporated herein by reference. This patent document has been published as U.S. patent application 20020133821 A1, and is herein incorporated by reference. This patent document relates to a data management system that combines the data of an EPG with other data for other types of content information, typically within the context of a home entertainment system. The system comprises a data base for representing schedule information associated with scheduled content information from a content provider such as a broadcasting station or a video-on-demand (VOD) service. In addition, the data base also represents inventory information that is associated with content information available from another resource, e.g., as recorded at the consumer's digital Personal TV Receiver during previous broadcasts, or from a CD or DVD jukebox. Accordingly, this system introduces a general type of guide, also referred to as an electronic content guide (ECG).

For menu navigation within a CE context, see, e.g., U.S. Ser. No. 09/487,149 (attorney docket US 000012) filed Jan. 19, 2000 for Maurice Cuijpers and Jan van Ee for JOG WHEEL FOR FAST WEB BROWSER NAVIGATION, published under PCT as WO200153925 and incorporated herein by reference. This patent document relates to user-control of a jumping highlight on the TV display monitor via a set-top box to select a user-interactive item in a Web document. To control the speed of the jumping highlight, the user manipulates a jog wheel on a remote. According to the orientation and speed of rotation of the wheel, the remote issues TAB or SHIFT+TAB IR commands at a higher or lower rate. For another example of menu navigation in a CE context see, e.g., U.S. Ser. No. 09/912,123 (attorney docket US 018108) filed 23, Jul. 2001 for Maurice Cuijpers, Jan van Ee and Roel Foppema for SEAMLESSLY COMBINED FREELY MOVING CURSOR AND JUMPING HIGHLIGHTS NAVIGATION, published as U.S. application no. 20030016249 and incorporated herein by reference. This document relates to a remote control device for operating on a menu, e.g., of a settop box, displayed on a display monitor. The remote has a force-sensitive resistor (FSR) for coarse or free navigation, and a keypad around the FSR for fine navigation. The user gets visual feedback by means of a highlighted item or a cursor when operating the FSR, and by means of the highlighted item for close-range navigation using the keypad. The FSR doubles as an “OK”- (or “confirm”- or “select”-) button so as to select the highlighted option.

For completeness, reference is made to U.S. Ser. No. 09/374,694 (attorney docket No. PHA 23,737; published under PCT as International Application WO 0113265A2) filed Aug. 16, 1999 for Chanda Dharap for SEMANTIC CACHING, herein incorporated by reference. This patent document relates to the caching of resources based on the semantic type of the resource. The cache management strategy is customized for each semantic type, using different caching policies for different semantic types. Semantic types that can be expected to contain dynamic information, such as news and weather, employ an active caching policy wherein the resource in the cache memory is chosen for replacement based on the duration of time that the resource has been in cache memory. Conversely, semantic types that can be expected to contain static resources, such as encyclopedic information, employ a more conservative caching strategy, such as LRU (Last Recently Used) and LFU (Least Frequently Used) that is substantially independent of the time duration that the resource remains in cache memory. Additionally, some semantic types, such as communicated e-mail messages, newsgroup messages, and so on, may employ a caching policy that is a combination of multiple strategies, wherein the resource progresses from an active cache with a dynamic caching policy to a more static caches with increasing less dynamic caching policies. The relationship between semantic content type and caching policy to be associated with the type can be determined in advance, or may be determined directly by the user, or could be based, at least partly, on user-history and profiling of user-interaction with the resources.

1. A data processing system for recording content items in a storage medium, wherein:
the system maintains a list with at least a particular one of the recorded content items scheduled for being deleted from the storage medium to provide storage capacity for a new content item scheduled for being recorded; and
the system has an output for providing a representation of the list indicating an order wherein the particular recorded items are scheduled for being deleted.

2. The system of claim 1, operative to notify the user of the list upon a predetermined event.

3. The system of claim 1, operative to enable a user to modify the list.

4. The system of claim 3, enabling a user to modify the order.

5. A method of providing a service to a user, the method comprising:
controlling storage capacity for storing electronic content items;
maintaining a list with at least a particular one of the recorded content items scheduled for being deleted to provide storage capacity for a new content item scheduled for being recorded; and
providing a representation of the list indicating an order wherein the particular items are scheduled for being deleted.

6. The method of claim 5, comprising enabling a user to be notified of the list.

7. The method of claim 5, comprising enabling a user to modify the list.

8. The method of claim 7, comprising enabling the user to modify the order.

9. The method of claim 5, comprising providing the storage capacity.

10. Software for installation on a PVR for:
enabling to maintain a list with one or more particular ones of multiple content items recorded at the PVR that are scheduled for being deleted to provide storage capacity for a new content item scheduled for being recorded; and
for enabling to provide a representation of the list indicating an order wherein the particular items are scheduled for being deleted.

11. The software of claim 10, enabling the user to modify the list.

12. The software of claim 10, enabling the user to modify the order.
